(19) United States
(12) Patent Application Publication
(10) Pub. No.: US 2013/0159212 A1
(43) Pub. Date: Jun. 20, 2013

(54) METHOD OF FINANCING REAL PROPERTY IMPROVEMENT

(71) Applicant: Larry D. Moody, Bradenton, FL (US)

(72) Inventor: Larry D. Moody, Bradenton, FL (US)

(73) Assignee: AXIS MANAGEMENT CORP.

(21) Appl. No.: 13/546,462

(22) Filed: Jul. 11, 2012

Related U.S. Application Data
(60) Provisional application No. 61/506,747, filed on Jul. 12, 2011.

(51) Int. Cl. G06Q 40/06

(52) U.S. Cl. CPC G06Q 40/06; G06Q 50/165
USPC 705/36 R

(57) ABSTRACT

The present invention provides a computerized network and system to finance improvements in real property with no up-front costs to the property owner. The method includes providing a management firm having a computerized database of potential investors and potential investments and for regulations and calculation of rewards for the improvement. The owner of the property provides a lease on the property in return for improvements on the property financed by the investors. The Management firm selects a property development company to provide the improvements and an LLC formed by the investors and the management company provides the funding. Upon completion of the improvement, the management company manages the property and collects rental receipts. In exchange, the property owner collects a share of the receipts as do the members of the LLC.

### CROSS REFERENCE TO RELATED APPLICATION(S)

This application claims benefit of U.S. Provisional Patent Ser. No. 61/506,747, filed Jul. 12, 2011, entitled “METHOD OF FINANCING PROPERTY IMPROVEMENT” by Larry D. Moody, the contents of which are incorporated in it's entirety herein by reference.

### FIELD OF THE INVENTION

The invention is directed to a method for financing improvements to real property without up-front costs to the property owner.

### BACKGROUND OF THE INVENTION

Improvements of real property can be expensive and stressful. Whether the improvement be a new development project, a redevelopment project or a mere refurbishment of existing structures, financial considerations may be responsible for driving the extent of the improvement possible. For commercial-type improvements financial considerations can be of paramount importance and require large amounts of capital and strategic investors. Therefore, improvement of real property oftentimes results in the property owner either selling the property to a commercial development entity or not embarking on the improvements at all.

In addition, should a property owner wish to develop a property for any commercial or non-commercial purpose he needs to obtain not just the financial backing to undertake the improvements but also the expertise for development in a particular field. For Example, restaurants have certain requirements with regard to safety regulations, including fire, health and labor standards as well as more mundane requirements such as having an appropriately designed and equipped kitchen to prepare food. Similar but specific requirements exist for commercial buildings as well as for residential buildings whether single family or multiple occupancy.

In addition, recreation areas that are used by many people also have specific and sometimes expensive building, safety and environmental requirements. One example is marinas which not only are used by many people but are also used to store or moor boats and equipment. For example, there are particular regulations for water areas, berthing areas, utilites, shoreline structures and land areas. Thus, even for those owners of existing marinas refurbishment and/or upgrading requires considerable capitol and expertise to do so.

Therefore there is a need for a mechanism to provide capitol, experience, expertise and specific understanding of the building needs and requirements for use in undertaking particular improvements of real property. Such uses include commercial and residential and recreational. The system should be computerized to provide all the participants access to the collected expertise available to the participants in the system to coordinate the progress of the improvement and to provide access to the allowed parties of the financial status and progress of the improvement.

### SUMMARY OF THE INVENTION

The present invention provides a computerized network and system to finance improvements in real property with no up-front costs to the property owner. The method includes providing a management firm having a computerized database of potential investors and potential investments and for regulations and calculation of rewards for the improvement. The owner of the property provides a lease on the property in return for improvements on the property financed by the investors. The Management firm selects a property development company to provide the improvements and an LLC formed by the investors and the management company provides the funding. Upon completion of the improvement, the management company manages the property and collects rental receipts. In exchange, the property owner collects a share of the receipts as do the members of the LLC.

In various exemplary embodiments, the invention provides a computerized method for improving real property comprising: i) providing a management and consulting (M&C) service including a computerized database comprising: a) desired property development/improvements and returns/risks associated with the property improvement; b) potential investors interested in investing in property improvements; ii) providing a database on a computer network, the database identifying: a) the geographical location of suitable property locations; b) the potential traffic of improved property users; c) availability of use rights for property owner customer; d) the potential for return on investment of property infrastructure/improvement; and iii) identifying a potential property owner customer; iv) providing a company to perform infrastructure improvements; v) performing infrastructure improvements in return for lease agreement with no up-front costs to property owner customer.

In various other exemplary embodiments, the invention provides a computerized method for building a marina comprising: i) providing a management service to improve or construct a marina; ii) providing a database on a computer network, the database identifying: a) the geographical location of suitable marina locations; b) the potential traffic of marina users; c) availability of use rights of marina customer; d)the potential for return on investment of property infrastructure/improvement; e) potential investors and requirements thereof; and iii) identifying a potential marina customer; iv) providing a company to perform infrastructure improvements; and v) performing infrastructure improvements in return for a moorage agreement with no up-front costs to customer.

In still other exemplary embodiments, the invention provides a computerized method for funding a convenience comprising: a) providing a computerized database network of customers owning rights in a convenience; b) providing a computerized database network of potential investors; c. cross-referencing the database of customers with potential investors to identify investors willing to invest in the convenience; d) providing a management consultant service controlling a central communications network; e. providing a member owned entity; and f) providing a convenience supply company wherein the management service uses the central communication network to: contract with the convenience owner to provide a lease of the convenience; wherein the management service contracts with a convenience supply company to install the convenience; and wherein the management service contracts with the investor to fund the convenience; wherein the management service and the investor form a member owned entity to fund the convenience; and wherein the member owned entity acquires a lease in the convenience.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be apparent from the description, as set forth hereinafter.

### BRIEF DESCRIPTION OF THE FIGURES

Various exemplary embodiments of the networks, systems and methods according to the invention will be described in detail, with reference to the following figures wherein:

FIG. 1 is a schematic diagram illustrating one embodiment of the real property improvement network and system according to the invention. In the diagram, the network connections between the participant systems are illustrated by the solid arrows, the associations between the participants in the network is illustrated by the dashed arrows.

FIG. 2 is a diagram representing the electronic flow of information in a central network computer system using one embodiment of an apparatus disclosed in the present invention.

FIG. 3 is a diagram representing a system apparatus used by a participant according to one embodiment of the present invention.

FIG. 4 is a schematic diagram illustrating the development of the improvement network 10 and the system 100. Dashed lines represent the associations between the participants of the network 10.

FIG. 5 is a schematic diagram illustrating the flow of capitol between the members of the network, according to one exemplary embodiment of the invention. Dashed lines represent the associations between the participants of the network 10.

FIG. 6 is a schematic diagram illustrating the flow of responsibility of project development corp. to the LLC and property owner. Dashed lines represent the associations between the participants of the network 10.

FIG. 7 is a schematic diagram illustrating further responsibilities of the property development corp. to the members of the network. Dashed lines represent the associations between the participants of the network 10.

FIG. 8 is a schematic diagram illustrating the association between the property owner, the property rental customer and the LLC according to one embodiment of the invention. Dashed lines represent the associations between the participants of the network 10.

FIG. 9 is a schematic diagram showing the responsibilities of the CPA to various participants in the network. Dashed lines represent the associations between the participants of the network 10.

FIG. 10 is a schematic diagram illustrating renew of the improvement lease for refurbishment of continuation of the improvement project. Dashed lines represent the associations between the participants of the network 10.

FIG. 11 is a schematic diagram showing the responsibilities of the CPA following a renewal contract illustrated in FIG. 10 according to one embodiment of the invention. Dashed lines represent the associations between the participants of the network 10.

### DETAILED DESCRIPTION OF THE EXEMPLARY EMBODIMENTS

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

As used herein the term “improvement” means a project that improves the value of real property, e.g., including new property development, redevelopment and/or refurbishment of property infrastructure.

The present invention provides a computerized network and system to finance improvements in real property with no up-front costs to the property owner. The method includes providing a management firm having a computerized database of potential investors and potential investments and for regulations and calculation of rewards for the improvement. The owner of the property provides a lease on the property in return for improvements on the property financed by the investors. The Management firm selects a property development company to provide the improvements and an LLC formed by the investors and the management company provides the funding. Upon completion of the improvement, the management company manages the property and collects rental receipts. In exchange, the property owner collects a share of the receipts as do the members of the LLC.

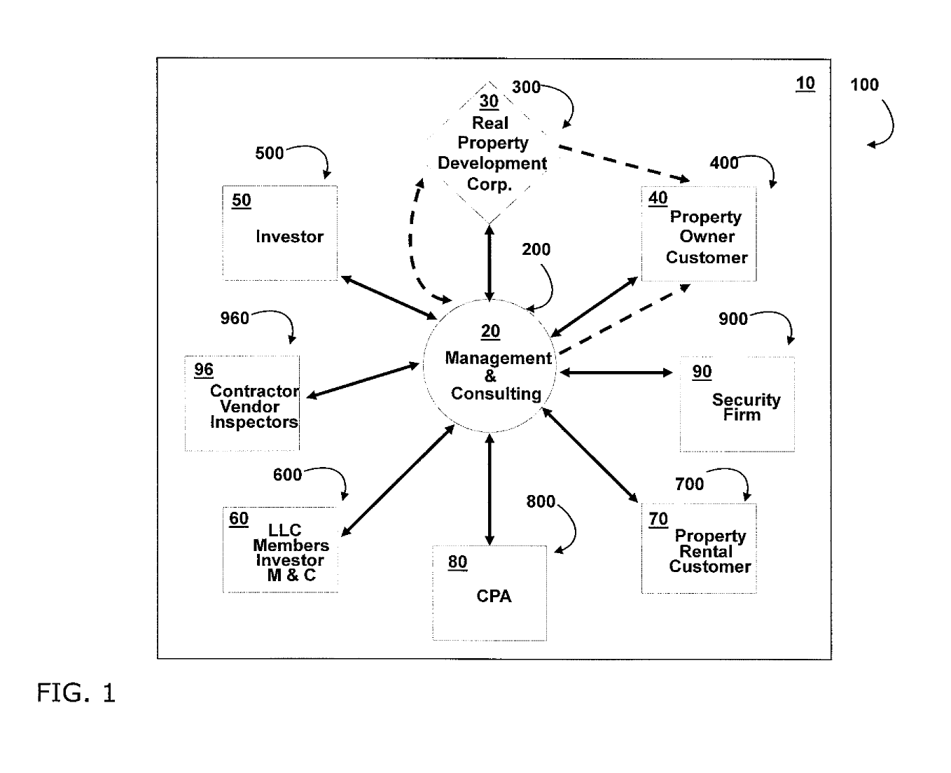

FIG. 1 is a schematic diagram illustrating one embodiment of the real property improvement network and system according to the invention. In the diagram, the network connections between the parts of system are illustrated by the solid arrows, the associations between the participants in the network is illustrated by the dashed arrows. As shown in FIG. 1, the network participants include a management and consultant entity (M&C) 20, which manages relationships between all the members of the network and through which information flows as illustrated by the solid arrows. In the embodiment shown, the members of the network include, a real property development corporation 30, a property owner customer 40, one or more investors 50, an LLC 60 formed between the investors and the M&C, one or more property rental customers 70, a CPA 80, a security firm 90 and, in most embodiments multiple sub contractors, vendors and inspectors 96. Further, FIG. 1 also illustrates the individual electronic systems used by the participants in accessing the network 10 through the property improvement system 100 via network apparatus 200, 300, 400, 500, 600, 700, 800, 900 and 960.

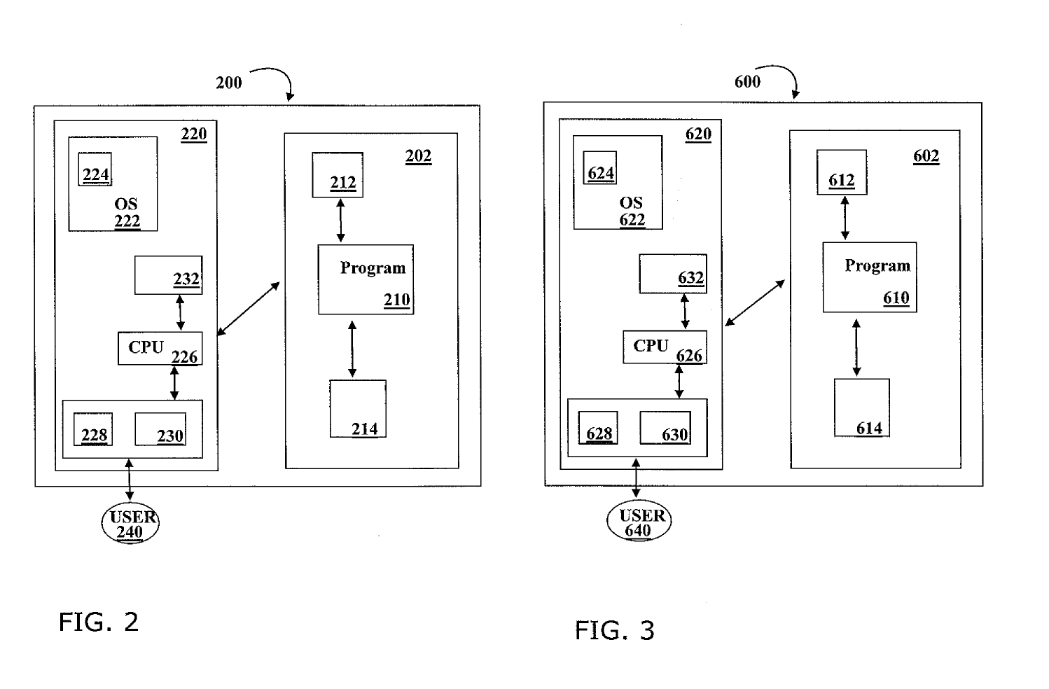

FIG. 2 illustrates central M&C network 200. As illustrated, in various embodiments, the centra network 200 comprises a data storage network 202 and a user terminal 220. The data storage network includes a database 212, one or more programs 210 and one or more data files 214. The user terminal 220 includes an operating system 222, one or more user programs 224, a processor such as a CPU 226, and a user interface 228/230 comprising an input 228 and display or monitor 230. Communication port 232 is further provided to allow communication between the central network system and the various participant systems 300, 400, 500, 600, 700, 800, 900, 960 etc.

As illustrated in FIG. 2, M&C 20 maintains a computerized database 212 of potential investors. The database may be segregated by the amount of risk the investor is willing to take, the amount of money the investor is willing to invest, the amount of return the investor requires etc. Upon receiving a contract for property development/refurbishment, one or more specialized program 210 matches up the needs of the property development and quantifies the risk and matches the same with those investors 50 in the database 212. Upon identifying and enrolling investors an LLC 60 is formed whose members comprise only the investors 50 and the M&C 20.

Other databases 212 contemplated by the invention include, a computerized database of property development projects for desirable investment. Accordingly, depending on the economic need and/or analysis, the M&C may identify particular economic climate that is beneficial for any particular type of real property improvement. Such improvements may include development of commercial construction, development of non-commercial property, recreational property and the like. In such instances, the M&C may identify a type of development that it recognizes could attract investors or it may identify a piece of property, either by referral from a property development company 30 or from a property owner 40 desirous of improving a property. In some embodiments, the M&C 20 or the property development corp. 30 will contact the property owner to identify the desire for development/refurbishment as illustrated in FIG. 1. Of course, those of skill in the art will recognize that a developer owner may contact the M&C directly or be referred to the M&C by an investor with a proposal for financing property development/refurbishment. The M&C 20 then acquires a contract from the property owner 40 that includes a multiyear lease agreement; verifies utilities agreements, verifies construction permits, verifies liability insurance and provides indemnification of any and all liability to M&C and a potential investor LLC.

FIG. 3, is a schematic diagram of one exemplary embodiment of a terminal apparatus 600 used by the non-M&C participants in the property improvement project. In the exemplary embodiment illustrated, the terminal apparatus 600 corresponds to one or more of the other participant terminals 300, 400, 500, 700, 800, 900, or 960. The participant terminal 600 includes a data storage system 602 and a terminal/operating system 620. Storage unit 602 includes database 612, program 610 and data files 614. Operating system 620 includes program files 622, CPU 624 and interface 628/630. As with the central network 200, the interface includes a monitor 630 and an input 628 and communication ports 632. The terminals 600 etc., can comprise, for example, virtually any device that provides communication with a workstation such as a network or other computers including desktop, portable, lap-top or mainframe computers, data terminals, dumb terminals, personal digital assistants, cellular phones or other electronic devices having communications capabilities. It should be appreciated that, generally, in most embodiments, communication directly between users other than the M&C is routed through the central network system 200. Although of course, direct communication between the participants may occur, especially electronically such as via email, text or other means of notification.

Those of skill in the art will appreciate that the communications systems described above are not limited to the particular arrangements shown. For example, the technology of data management systems continues to explode to the extent that any particular user needing to access the system may do so remotely with any computerized system, as shown at 600 which may comprise a laptop computer, a smart phone or the like, especially in those embodiments where the apparatus can access the internet or satellite communications systems. For example, an LLC member may be in an airport and connect to a wireless network and access such data as project completion, payments schedule, inspection certificates provided etc.

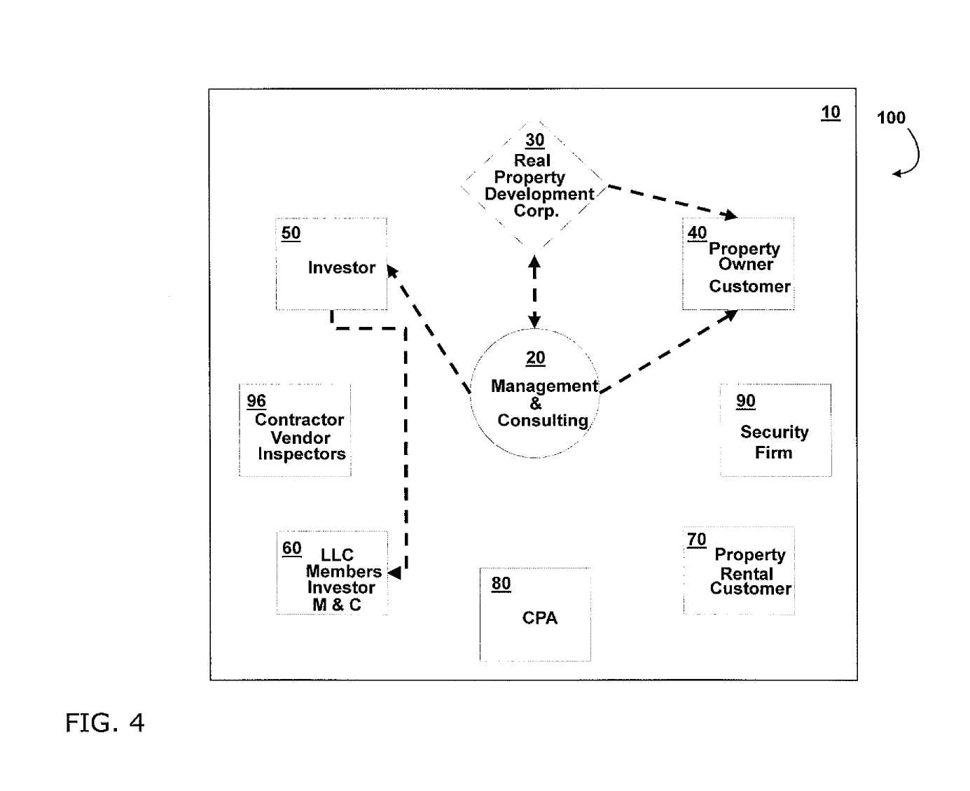

FIG. 4 is a schematic diagram illustrating the development of the improvement network 10 and the system 100. Dashed lines represent the associations between the participants of the network 10. As shown in FIG. 4, in this embodiment, the M&C 20 contacts potential investors 50 and requests funding for the property improvement project. Such funding may include the costs for all construction and development including utilities, security, freight and sales tax. Upon enrollment of the investors 50, the investors fund a member owned LLC 60, the members of which include only the investors 50 and the M&C 20.

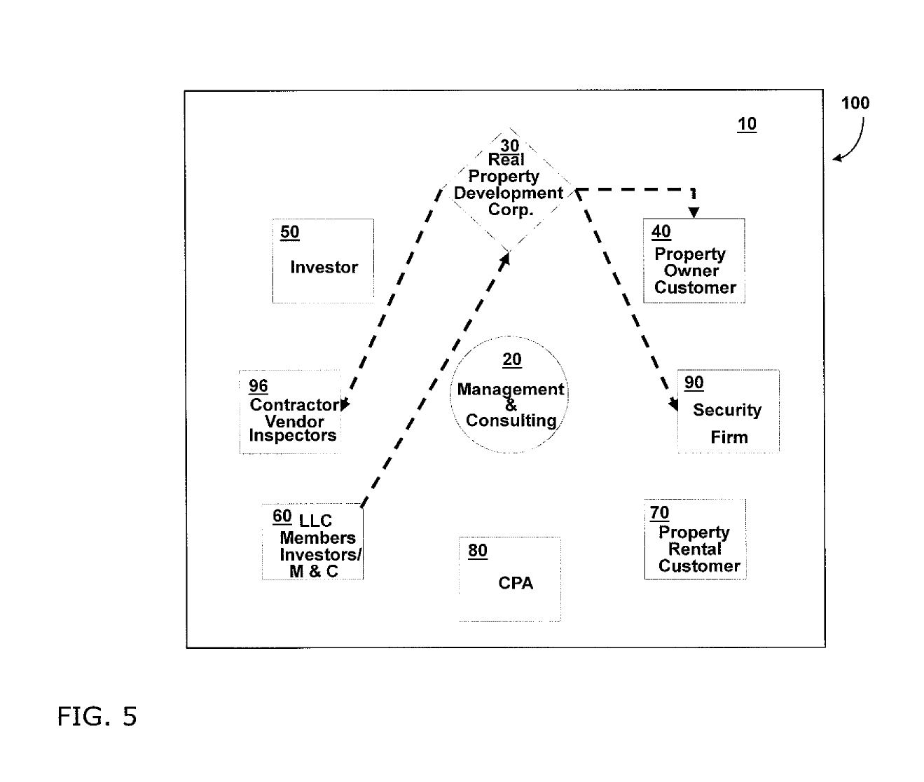

FIG. 5 is a schematic diagram illustrating the flow of capitol between the members of the network, according to one exemplary embodiment of the invention. As shown, the LLC 60 funds the development corp. 30 for sales contracts that include the cost of the property development. In return, the LLC 60 takes a 100% lien on the property development until completion certificates are presented and site inspection is completed by the contractors. The property developer 30 is responsible for payment of all contractors and the security firm and resolves all accounts payable and receivable. In some embodiments, during this part of the method, the CPA has not been engaged during the installation process. In these and various other embodiments, the property development corp. acts as a general contractor and project liaison with the property owner to assure satisfactory installation.

As schematically shown in FIG. 1, each of the participant terminals 300, 400, 500, 600, 700, 800, 900, and 960, etc., communicate directly with central managing system 200 via communication network components represented by the solid arrows, allowing concurrent transactions and data transfers to occur. Other types of arrangements are possible. For example, communications between the central managing system and the participant terminals can employ virtually any communications technology known today or later developed. The geographical spacing between the central managing system and the participant terminals can have virtually any scale desired. For example, the entire network 10 can be located in a single room, or in a single building or building complex or campus.

Of course, those of skill in the art will recognize that the property development network 10 can be located nationwide or internationally, as may be desired or necessary. Those of skill in the art will appreciate that the property improvement network may take on any form, and may employ wire, cable or wireless components, for example. In various exemplary embodiments, network 10 can be configured as an open connection or network such as the internet, a wide area network, a telephone network, a satellite network, an on-line network, a closed circuit television network or the like. Network 10 can also take the form of an Ethernet arrangement or any other suitable communications arrangement or configuration that can link workstations, particularly workstations including one or more data processing computers.

The participant terminals 300, 400, 500, 600, 700, 800, 900, and 960 can comprise any one of the many different types of electronic devices known today including a programmable computer, a telephone or smart phone, or any device capable of communicating via the internet or satellite such as a reading tablet or the like. The terminals preferably includes an input device, including a keypad, keyboard touch screen or mouse or a remote control device. Systems, articles and apparatus contemplated by the present invention preferably comprise digital devices, but could also comprise analog or hybrid electronic or non-electronic devices, as may be desired.

System Apparatus

As discussed for FIG. 2, the central managing system 200 is used by M&C 20 to supervise the property development project 10. In one example, system apparatus 200 comprises one or more storage devices 202 and user terminal 220. In various exemplary embodiments, the storage devices 202 include one or more programs 210, one or more databases 212 and one or more data files. In various other exemplary embodiments, the operating system 220 includes one or more system programs 224, one or more processors 226 and one or more user interface comprising at least an input 228 and a display 230 allowing interface between the operating system 200 and the users 20/240. In addition, the operating system includes communication ports 232 allowing communication between the various participants 30, 40, 50, 60, 70, 80, 90 and 96 in the property improvement as shown in FIG. 1. The processor 224 in one example comprises a central processor unit (“CPU”). The processor 224 executes one or more instructions of one or more programs 210, under control of an operating system 222 employing one or more system programs 224. The program 210 in one example comprises one or more subroutines and one or more variables, as will be understood by those skilled in the art. The storage device 202 in one example comprises at least one instance of a recordable data storage medium, as described herein. The storage device 202 stores the program 210, and one or more databases 212, and one or more or data files 214.

The interface components 228/230 in one instance comprises a graphical user interface (“GUI”). In some exemplary embodiments, the interface component 228/230 allows a service provider or other user 240 to execute one or more programs 210. The program 210, in one example, comprises one or more subroutines, to carry out the property development methods and operations to be described herein. In one instance, program 210 includes one or more subroutines to collect, publish, interpret or otherwise process information which supports rules and other aspects of operation of the financial activity. In another instance, program 210 includes one or more subroutines for implementing principles of operation for the property improvement activity.

In various exemplary embodiments, the interface component 228/230 allows the user 20/240 to verify or otherwise interact with one or more results of the program 210. In some embodiments, the interface component 228/230 allows the user 240 to set one or more input values or operating parameters for the program 210. In the exemplary embodiment illustrated in FIG. 2, the interface includes a display device 230 and a data input device 228 which allow a user 20/240 to set up the central managing system according to desired operating objectives. With the interface component 228/230, a user can access, read or write to the program 210, the databases 212 and the data files 214.

Included in the apparatus 200 embodying system is a communication port 232 which provides two-way communication with the terminals 300, 400, 500, 600, 700, 800, 900 and 960. Communication port 232 can employ virtually any communications protocol, data format and other organizational, communication or other known content that is in use today. It is generally preferred that the communications network employed between the central managing system 200 and the participant terminals comprise an interactive device taking any suitable form.

The property improvement system 100 embodying the improvement network 10, in one exemplary embodiment comprises a plurality of components such as one or more of electronic components, hardware components, and computer software components. A number of such components can be combined or divided in the property improvement system 100. An exemplary component of the property improvement system 100 employs and/or comprises a set and/or series of computer instructions written in or implemented with any of a number of programming languages, as will be appreciated by those skilled in the art.

The property improvement system 100 in one example employs one or more machine (e.g. computer)-readable (hereinafter “computer-readable”) signal-bearing media. The computer-readable signal-bearing media store software, firmware and/or assembly language for performing one or more portions of one or more embodiments of the invention. Examples of a computer-readable signal-bearing medium for the property improvement system 100 comprise a storage component such as one or more storage devices 202. The computer-readable signal-bearing medium for the property improvement system 100 in one example can comprise one or more of a magnetic, electrical, optical, biological, and atomic data storage medium. For example, the computer-readable signal-bearing medium can comprise floppy disks, magnetic tapes, CD-ROMs, DVD-ROMs, hard disk drives, and electronic memory. In another example, the computer-readable signal-bearing medium comprises a modulated carrier signal transmitted over a network comprising or coupled with the property improvement system 100, for instance, one or more of a telephone network, a local area network (“LAN”), a wide area network (“WAN”), the Internet, and a wireless network.

As discussed, FIG. 2 illustrates the communication system 200 comprising the M&C central network 20. The databases 212 in one example comprise a property owner/property customer database, an administrator or system database, an investor database, a database of environmental regulations by country, a database outlining various property ownership laws and regulations searchable by country, a rules database and a and a vendor database. The investor database contains a list of investors and their requirements for investing, such as, for example the type of property development they want to invest in, the return they are willing to accept, the amount they are willing to invest,

The property owner/property customer database maintains a list of property owners/property customers and provides estimates on the productivity and return of capitol invested in the development of identified properties. In some embodiments, the property owner/property customer database further includes information regarding the eligibility of property owner/property customer to participate in the development activity. For example, in the case of redeveloping a marina, various environmental regulations may control the type and size of development and in come cases of sensitive environments, may preclude development.

The administrator database contains data and other information needed to operate the property improvement activity. Included, for example, are ongoing “real-time” or “moving” totals of the number of investors and the amount invested, the total of all funds invested, the number of other investors. If desired, the administrator database can also include real-time estimates of payout amounts corresponding to the participant's requirements. In addition, it will be appreciated that while the M&C 20 controlling the central network 200 will have access to all financial information, only the CPA's 80 will have access to financial information as well and will have the ability to input such financial data into the financial database 212. Further, in some embodiments, while the C &A controlling the network will have access to the financial data, the data input by the CPA will be read-only and will not be subject to manipulation by any of the users.

The rules database 212 contains rules or other principles of operation for the development activity. The rules database contains a set of “rules” or principles which govern the ongoing financial activity, in a specific or in a general way (e.g. rules defining the authorities, or external objective independent information sources to be relied upon for a final, factual decision or conclusion). For example, rules are provided regarding allowance of conflicts of interest between investors who also may be property owner customers or property rental customers. Other examples may include the amount of investment any one investor is able to make or limitations on the withdrawal or such funds prior to the conclusion of the development project. The rules also include eligibility requirements, personal financial payment requirements, and sliding scales affecting payouts such as timing and deadlines.

The rules may be wholly or partially public (i.e. available to participants) or private (i.e. available only to those authorized by the system administrator). In one instance, the rules database also governs the course of conduct of specific aspects of the development activity

If desired, the points or other value pertaining to the investor's remuneration can be “hidden” or incorporated within a calculation, and need not be expressed in an explicit reference. In another instance, the rules database contains definitions of those investors eligible to engage in the financial activity. In a further instance, the rules database contains principles of operation governing funds transfers between the property development and qualifying participants. The rules database may also govern access that a participant has to certain information concerning the development activity, such as the number of individuals participating, the average or largest financial investments currently being made, and the raw total of funds currently collected for the improvement of interest.

The data files 214 comprise data information such as land use regulations, environmental regulations, reporting of natural events activity, and statistics compiled from historical information. For example, a history of such information such as hurricanes and/or earthquakes may be particularly useful if the improvement project is a marina. In such cases, marina's developed in hurricane prone waters could be designed for more robust marina assembly.

Central Managing Apparatus

The central managing apparatus 200 (FIG. 2) and various participant terminal apparatus 300, 400, 500, 600, 700 etc. (FIG. 3) in one embodiment comprise a plurality of components such as one or more of electronic components, hardware components, and computer software components. A number of such components can be combined or divided in the apparatus. An exemplary component of the apparatus employs and/or comprises a set and/or series of computer instructions written in or implemented with any of a number of programming languages, as will be appreciated by those skilled in the art.

The apparatus', in one exemplary embodiment, employs one or more computer-readable signal-bearing media. The computer-readable signal-bearing media store software, firmware and/or assembly language for performing one or more portions of one or more embodiments of the invention. Examples of a computer-readable signal-bearing medium for the apparatus comprise the storage components 202, 602. The computer-readable signal-bearing medium for the apparatus in one example comprises one or more of a magnetic, electrical, optical, biological, and atomic data storage medium. For example, the computer-readable signal-bearing medium comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, or a wireless network.

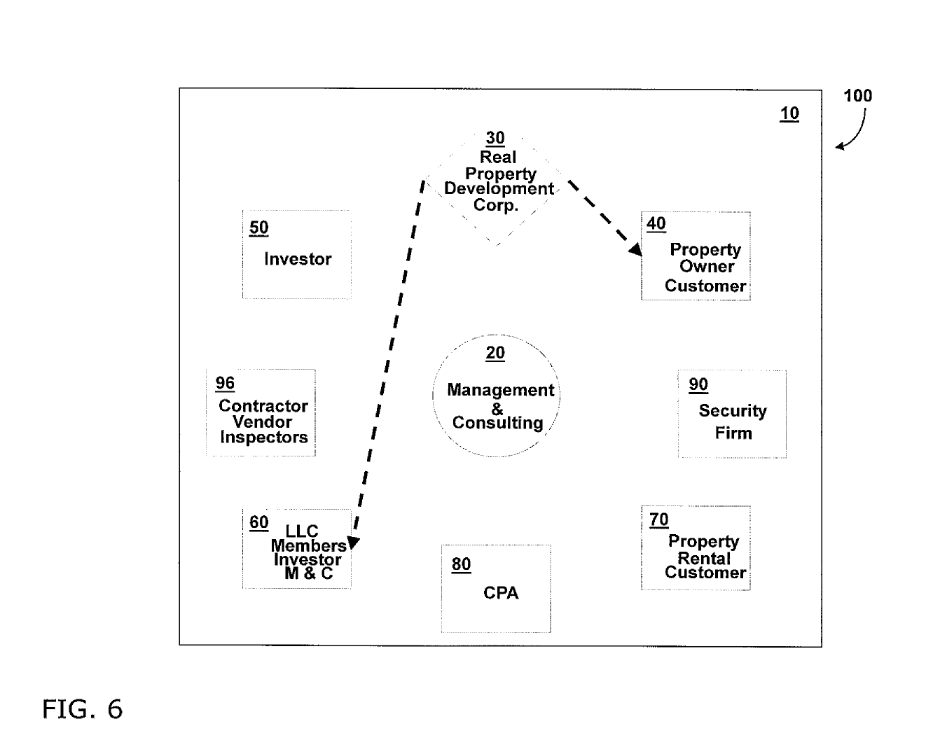

FIG. 6 is a schematic diagram illustrating the flow of responsibility of property development corp. 30 to the LLC 60 and property owner 40. FIG. 6 illustrates, in one embodiment, the property development corporation 30 provides the member owned LLC 60 appropriate construction and government completion certificates as needed for each project. As discussed the development network 10 allows the LLC members 60 to access network data regarding development activity and completion of milestones and ongoing timelines as well as monies dispersed and collected via system 100. In one embodiment, the property development corp. 30 may file all necessary permits, certificates and schedules for completion/inspection with the LLC 60 via the central network system 200 accessible by the M&C, investors and any other members of the improvement network 10 deemed authorized. As illustrated by the arrow from the property development corp. 30 to the property owner 40, coordination is required between the property owner and the property development corp. to verify that all required permits, insurance, right of ways, utility easements, insurance etc. has been obtained

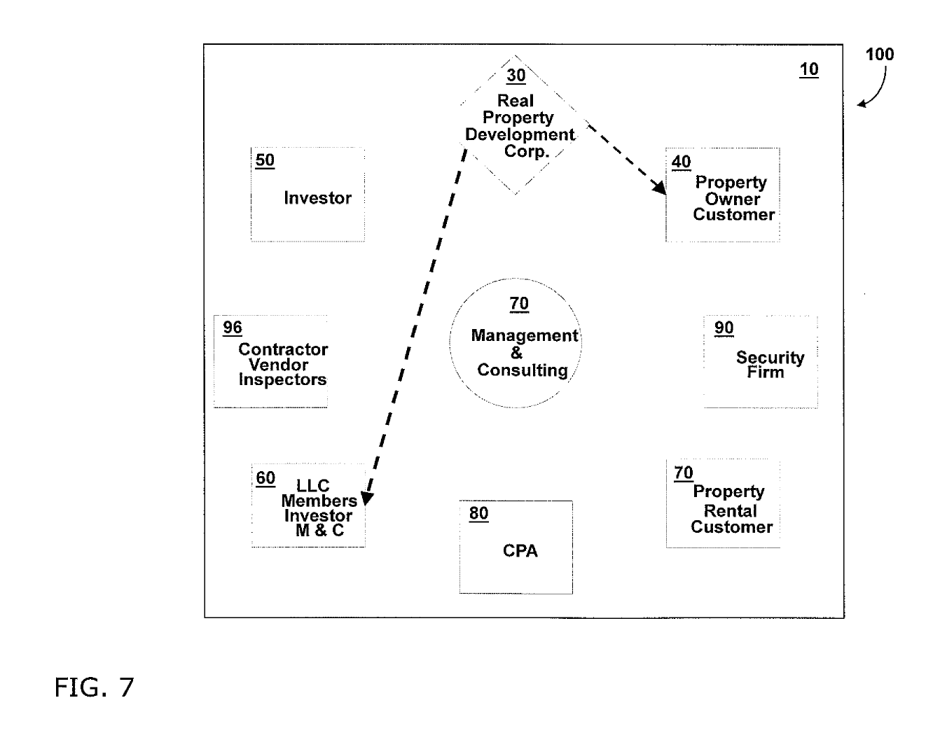

FIG. 7 is a schematic diagram illustrating further responsibilities of the property development corp. 30 to the members of network 10. FIG. 7 illustrates the project development corporation 30 provides the M&C 20 with indemnification for all products and construction and installation and ongoing product/construction liability insurance. The development corporation also provides all completion certificates to the M&C 20 which are loaded into the central network communication system 200 viewable by members of the LLC 60 via system 100.

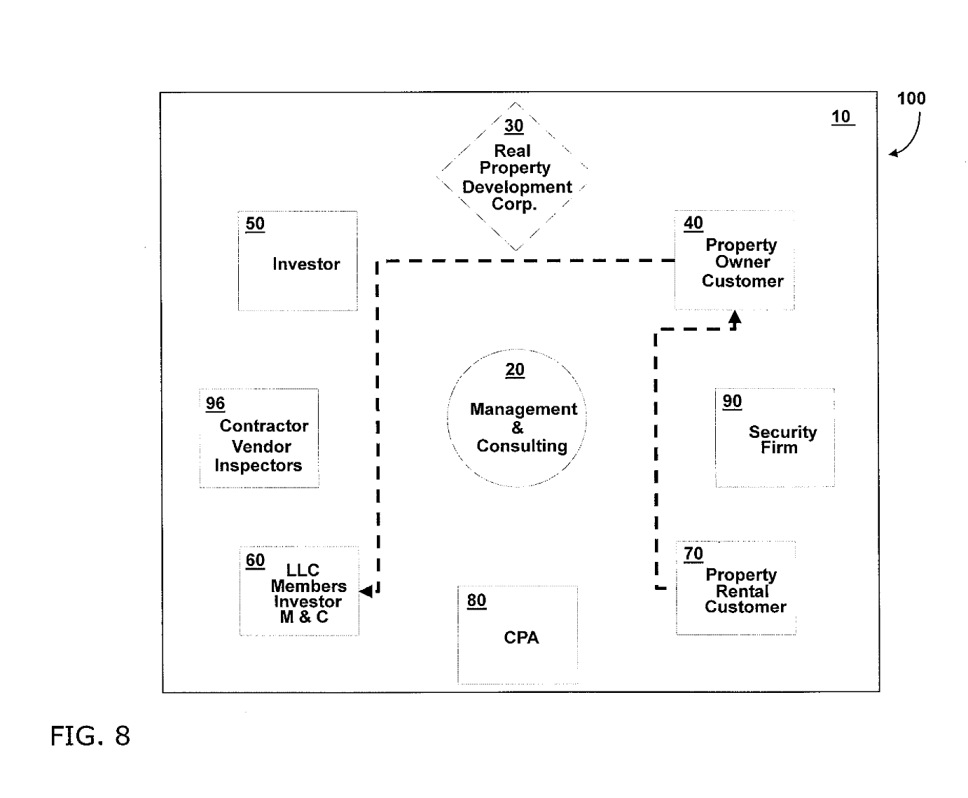

FIG. 8 is a schematic diagram illustrating the association between the property owner 40, the property rental customer 70 and the LLC 60 according to one embodiment of the invention. FIG. 8 illustrates that the property owner 40 contacts the property rental customer 50 for rental/lease agreement and the property owner 40 provides the LLC 60 rental contract for signature. All monies/payments are made to the member owned LLC 60 and the rental customer 40 provides personal insurance coverage accompanying contract. M&C 20 manages all rental customers. M&C 20 manages all rental customer relationships. M&C 20 manages all relationships and transactions between all panes involved in the improvement network 10 and makes appropriate information available to the allowed parties.

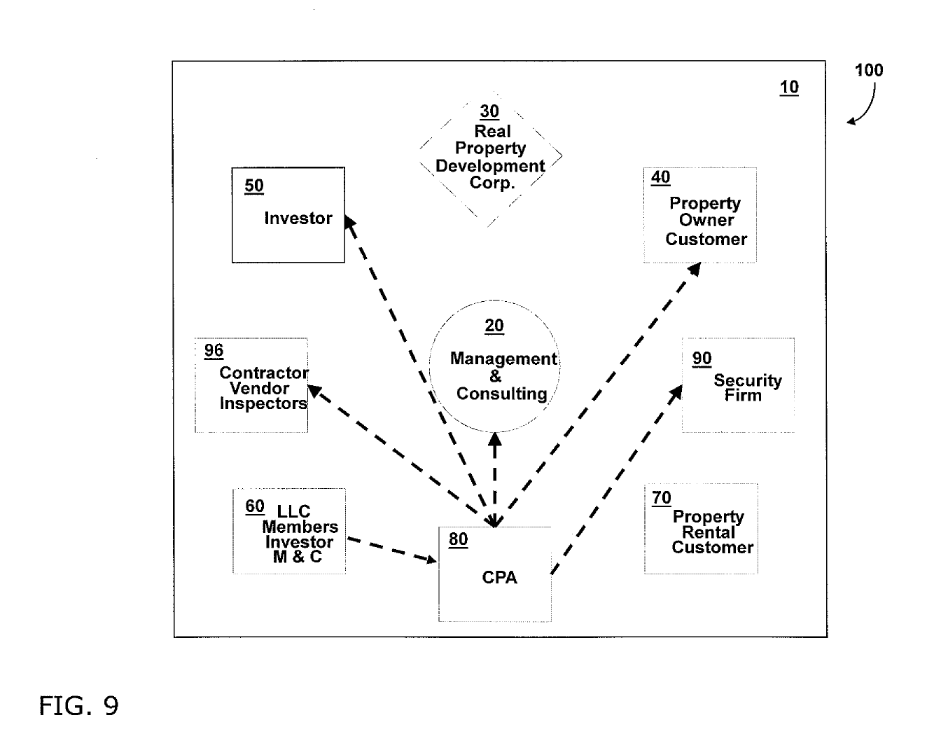

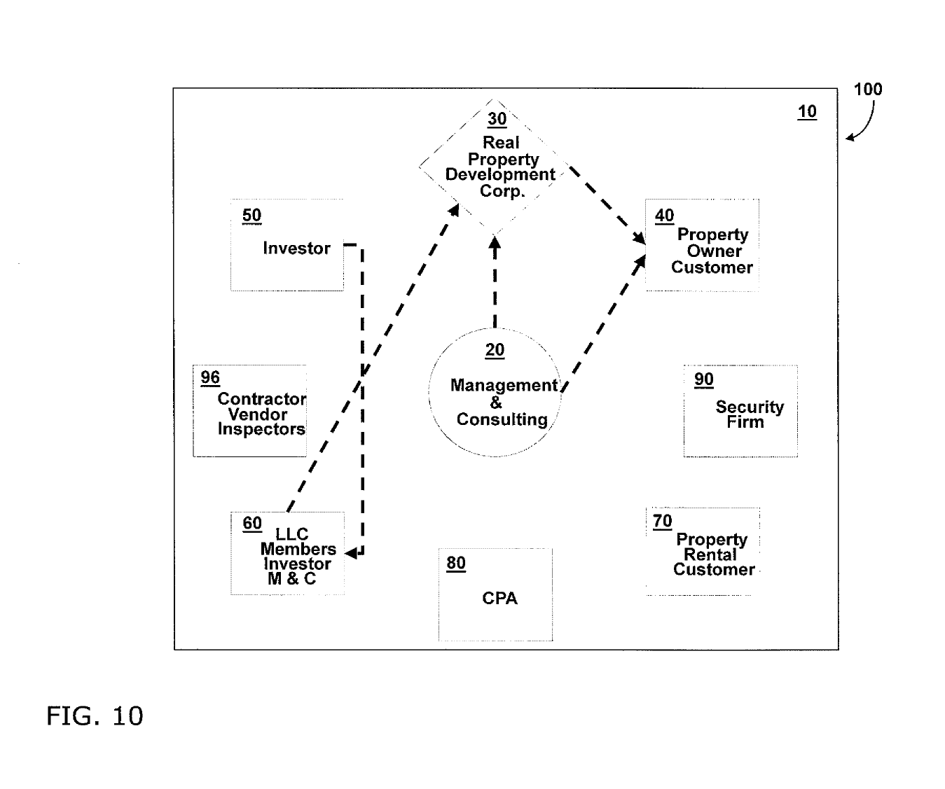

FIG. 9 is a schematic diagram showing the responsibilities of the CPA to various participants in the network. As shown a CPA 80 firm engaged by the LLC 60 and/or the M&C provides information regarding: accounting for all receipts and disbursements; pays investors 50 as a priority payee on a fixed basis. In some embodiments, the pay is amortized on a monthly repayment schedule. The CPA firm 80 pays all repair, installation contractors, vendors, inspectors from accrual accounts; pays a security surveillance firm 90 engaged by the M&C 20 and pays investors 50 a “premium” of receipts after costs (repairs, and inspections). The CPA 80 is also responsible for paying the property owner 40 an agreed upon share of the adjusted gross profits (GP). The CPA 80 also is responsible for paying an agreed share of the GP to the M&C 20.

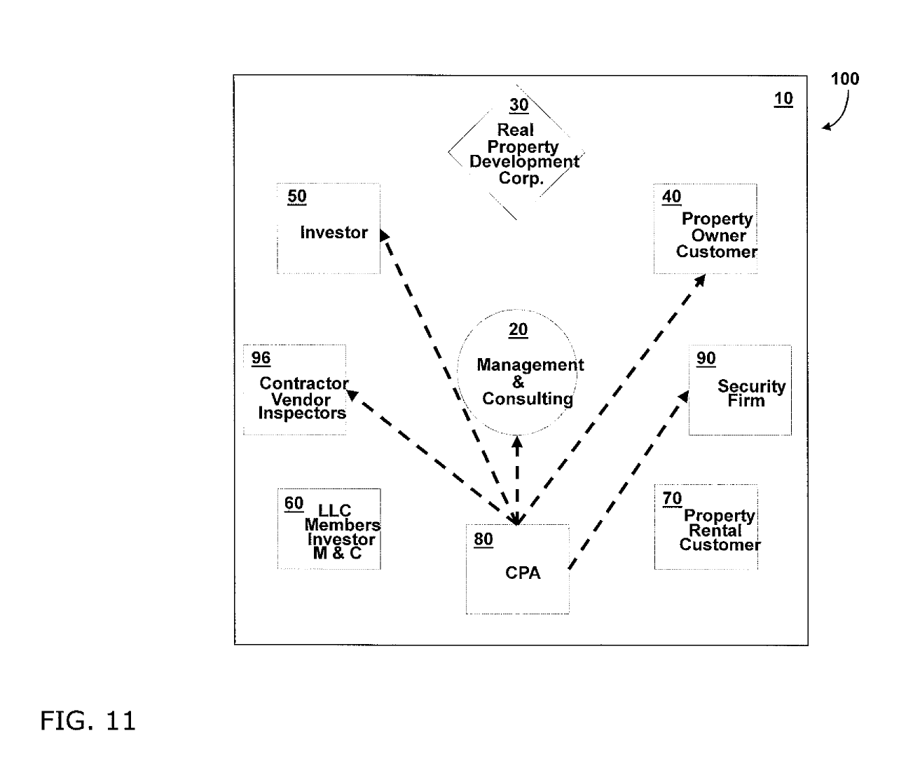

FIG. 10 is a schematic diagram illustrating renewal of the improvement lease for refurbishment of continuation of the improvement project. FIG. 10 illustrates that in some embodiments, the M&C 20 may contract with the property owner to renew or create an extended property management agreement for an extended period of time, such as, for example, 10 years. In these embodiments, the M&C 20 will notify the development corp. 30 of the transaction and the investor will fund the LLC 60 for refurbishment of the property as needed.

FIG. 11 is a schematic diagram showing the responsibilities of the CPA 80 following a renewal contract illustrated in FIG. 10, according to one embodiment of the invention. FIG. 11 illustrates a further aspect of the embodiment illustrated in FIG. 10 wherein the member owned LLC 60 engages the CPA firm 80 to provide accounting for all receipts and disbursements, pay the investors a priority payee on an agreed fixed term, pay contactors, vendors inspectors 96 from and accrual account, pay security firm 90, pay an investor 50 a “premium” of receipts after costs, pay property owner customer 40 an agreed share of adjusted GP, and pay the M&C 20 an agreed share of adjusted GP.

Various exemplary embodiments of methods and systems as generally described above according to this invention will be understood more readily by reference to the following examples, which are provided by way of illustration and are not intended to be limiting of the invention in any fashion.

### EXAMPLE 1

### Marina Development

In this example, the development corp. 20 (Docking Systems, Inc. (DSI)) supplies and builds modular docking systems for marinas. In this example, the formation of the improvement network may begin either by Docking Systems, Inc. contacting the marina owner 40 to identify whether redevelopment of the marina is of interest. In another example, the formation of the network may begin by the marina owner 40 contacting Docking Systems, Inc. 30 to identify the availability/affordability of the modular docking systems. In another example, the Management and Consulting entity 20 may identify a particular marina as having increased potential if its infrastructure was redeveloped and contact the marina owner regarding interest in redeveloping the marina.

Following interest by the marina owner 40 , DSI. 30 secures a customer contract with the marina owner 40. The contract includes: DSI product, freight, installation, utilities, security installation and applicable sales tax. DSI 30 contacts M&C 20 to contact marina owner customer 40. M&C 20 contacts Marina customer 40 and acquires a contract that includes a 10 year lease, verifies water lease permits, verifies construction permits, verifies liability insurance, provides indemnification of any/all liability to M&C 20 and Member owned LLC 60.

M&C 20 then contacts investors 50 and requests funding for the following: DSI product, installation expense (allowance for add-ons and overruns) utilities, security system, freight and sales tax. Investors 50 fund a member owned LLC 60 comprising only the investors 50 and the M&C 20.

Member owned LLC 60 funds DSI 30 for sales contract that includes: DSI product at dealer cost, installation, utilities, freight, security system and sales tax. Member owned LLC 60 takes a 100% lien on DSI product until installation completion certificates are presented and site inspection is completed by DSI 30. DSI 30 installs marina project and completes the following: installation completion certification; pays all contractors/vendors 96 and security 90; resolves all accounts payable/receivable. Those of skill in the art will appreciate that engagement and payment of contractors will sometimes require payment up front for equipment, followed by a monthly service fee. It may also include a year/multi-year lease that includes the initial price of the equipment combined with the monthly monitoring fee.

DSI 30 provides member owned LLC 60 the following: project completion certification; utility inspection certificates; security inspection certificates; wildlife/fisheries or any other required government completion certificates; current ongoing product liability insurance with indemnification; warranty/customer service.

DSI 30 provides M&C 20, member owned LLC 60 and investors 50 the following: indemnification for all product and installation liability; completion certificates; current and on-going product liability insurance.

Marina rental customer 80 contacts marina owner 40 for slip rental. Marina owner 40 provides LLC 60 contract for signature. All monies/payments are made to member owned LLC. Moorage/slip rental customer 80 provides personal insurance coverage accompanying contract. M&C 20 manages all moorage/slip rental customers. M&C 20 manages relationships and transactions between all parties involved in the business process. In various embodiments, credit card payment or account information that will be used for all moorage payments. All checks will be payable to the LLC and contracts will be provided in the marina office and online. The 24/7 security system will be monitored remotely and provide a visual on all slips.

The member owned LLC 60 engages a CPA firm 70 to provide the following services: accounting for all receipts and disbursements; pay investor as a priority payee on a 10 year (120 month) amortized repayment schedule; pay all repair contractors, vendors, inspectors 96 from accrual account; pay security surveillance firm 80; pay investor 50 “premium” of receipts after costs (repairs, inspections); pay marina owner customer 40 a 50% share of adjusted GP; pay M&C 20 50% share of adjusted GP.

### EXAMPLE 2

### Ten Year Renewal Agreement

M&C 20 contacts marina owner 40 and secures a renewal 10 year lease agreement. M&C 20 notifies DSI 30 of transaction. Investors 50 fund member owned LLC 60 for re-facing marina, including new decks, side panels, repairs etc. Member owned LLC 60 provides purchase order and funds DSI 30 for re-facing marina, including all applicable costs at dealer price. DSI 30 completes re-facing installation and provides completion and lien free certificate to member owned LLC 60.

Member owned LLC 60 engages CPA 70 firm to provide the following services: accounting for all receipts and disbursements; pay investor 50 as priority payee on a 10 year (120 month) amortized (P&I) monthly repayment schedule; pay all repair contractors, vendors, inspectors 96 from accrual account; pay security surveillance firm 90; pay investors 50 “premium” of receipts after costs (repairs, inspections); pay marina owner customer 40 a 50% share of adjusted GP; pay M&C 20 a 50% share of adjusted GP.

The following paragraphs enumerated consecutively from 1 to 76 provide for various aspects of the present invention. In a first paragraph (1), the invention provides:

1. A computerized method for improving the infrastructure of real property comprising:
i. providing a management service including a computerized database comprising:
   a) desired property development/improvements and returns/risks associated with the property development/improvement;
   b) potential investors interested in investing in property development/improvements;
ii. providing a database on a computer network, the database identifying:
   a) the geographical location of suitable property locations;
   b) the potential traffic of improved property users;
   c) availability of use rights for property owner customer;
   d) the potential for return on investment of property infrastructure/improvement; and
iii. identifying a potential property owner customer;
iv. providing a company to perform infrastructure improvements;
v. performing infrastructure improvements in return for lease agreement with no up-front costs to property owner customer.

2. The method of paragraph 1, further comprising providing an investor, the investor providing a source of investment capital.

3. The method of any of paragraphs 1-2, wherein the investor is provided access to the network identifying risks and benefits involved in the investment.

4. The method of any of paragraphs 1-3, wherein a company capable of building the infrastructure is identified.

5. The method of any of paragraphs 1-4, wherein the investor and the management service form an entity to provide the infrastructure.

6. The method of any of paragraphs 1-5, wherein the entity owns the infrastructure.

7. The method of any of paragraphs 1-5, wherein the entity is an LLC or an LTD.

8. The method of any of paragraphs 1-6, wherein the customer provides an annual use agreement to the entity.

9. The method of any of paragraphs 1-7, wherein the use agreement is for 10 years.

10. The method of any of paragraphs 1-7, wherein the customer remits all payments to the entity.

11. The method of any of paragraphs 1-10, wherein the management service identifies the infrastructure needed and contacts the company to provide infrastructure development.

12. The method of any of paragraphs 1-11, wherein, upon completion of the infrastructure development, the customer provides use of the infrastructure to users.

13. The method of any of paragraphs 1-12, wherein the infrastructure users pay a use fee directly to the entity.

14. The method of any of paragraphs 1-13, wherein the entity engages an accounting firm to collect, disburse and account all funds to all parties.

15. The method of any of paragraphs 1-14, wherein all fees remitted to the entity are maintained by the accounting firm.

16. The method of any of paragraphs 1-15, wherein the accounting firm pays the investor out of use fees on principal and investment.

17. The method of any of paragraphs 1-16, wherein the accounting film pays the company for repairs to the infrastructure.

18. The method of any of paragraphs 1-17, wherein the accounting firm pays the management service a revenue share.

19. The method of any of paragraphs 1-18, wherein the accounting firm pays the customer a revenue share.

20. The method of any of paragraphs 1-19, wherein the accounting firm pays the investor a premium.

21. The method of any of paragraphs 1-20, wherein the accounting firm prepares a monthly/quarterly and year end statements for the entity.

22. The method of any of paragraphs 1-21, wherein all financial data is available to the entity via the computer network.

23. The method of any of paragraphs 1-22, wherein the property is coastal.

24. The method of any of paragraphs 1-23, wherein the customer owns water rights or mooring rights in the suitable marina location.

25. The method of any of paragraphs 1-24, wherein the infrastructure improvement is a marina.

26. The method of any of paragraphs 1-25, wherein the customer pays no up front costs.

27. The method of any of paragraphs 1-26, wherein the customer provides all permits and insurance.

28. The method of any of paragraphs 1-27, wherein the investor has access to the network identifying the progress of the infrastructure development and the cost of the development.

29. The method of any of paragraphs 1-28, wherein the convenience is a marina.

30. The method of any of paragraphs 1-29, wherein the customer pays no up front costs.

31. The method of any of paragraphs 1-30, wherein the customer provides all permits and insurance.

32. The method of any of paragraphs 1-31, wherein the investor has access to the database network identifying the progress of the infrastructure development and the cost of the development.

33. A method for building a marina comprising:
i. providing a management service to improve or construct a marina;
ii. providing a database on a computer network, the database identifying:
   a) the geographical location of suitable marina locations;
   b) the potential traffic of marina users;
   c) availability of use rights of marina customer;
   d) the potential for return on investment of property infrastructure/improvement; and
iii. identifying a potential marina customer;
iv. providing a company to perform infrastructure improvements; and
v. performing infrastructure improvements in return for a moorage agreement with no up-front costs to customer.

34. The method of paragraph 33 wherein the management service and the investor create an entity.

35. The method of any of paragraphs 33-34, wherein the entity takes lien on infrastructure until completion.

36. The method of any of paragraphs 33-35, wherein the rights in the infrastructure is a lease on the marina.

37. The method of any of paragraphs 33-36, wherein the entity is an LLC or an LTD.

38. The method of any of paragraphs 33-37, wherein the company provides liability insurance in the marina.

39. The method of any of paragraphs 33-38, wherein the company provides liability indemnification to the entity.

40. The method of paragraph 33, wherein collecting, accounting and disbursing of moneys is maintained in the computer network.

41. The method of any of paragraphs 33-40, wherein the computer network is maintained by an accounting firm.

42. The method of any of paragraphs 33-41, wherein the customer provides all permits and insurance.

43. The method of any of paragraphs 33-42, wherein the investor funds company for marina and installation costs.

44. The method of any of paragraphs 33-43, wherein the company installs a marina.

45. The method of any of paragraphs 33-44, wherein the entity engages an accounting firm to collect, disburse and account all funds to all parties.

46. The method of any of paragraphs 33-45, wherein all fees remitted to the entity are maintained by the accounting firm.

47. The method of any of paragraphs 33-46, wherein the accounting firm pays the investor out of proceeds (10 yr amortized) on principal and interest.

48. The method of any of paragraphs 33-47, wherein the accounting firm pays the company for repairs to the marina.

49. The method of any of paragraphs 33-48, wherein the accounting firm pays the company a revenue share.

50. The method of any of paragraphs 33-49, wherein the accounting firm pays the customer a revenue share.

51. The method of any of paragraphs 33-50, wherein the accounting firm pays the investor a premium.

52. The method of any of paragraphs 33-51, wherein the accounting firm pays a security company to maintain security at the marina.

53. The method of any of paragraphs 33-52, wherein the accounting firm prepares a monthly/quarterly and year end statements for the entity.

54. A method for funding a convenience comprising:
a. providing a computerized database network of customers owning rights in a convenience;
b. providing a computerized database network of potential investors;
c. cross-referencing the database of customers with potential investors to identify investors willing to invest in the convenience;
d. providing a management consultant service controlling a central communications network;
e. providing a member owned entity; and
f. providing a convenience supply company
   wherein the management service uses the centra communication network to:
contract with the convenience owner to provide a lease of the convenience;
   wherein the management service contracts with a convenience supply company to install the convenience; and
   wherein the management service contracts with the investor to fund the convenience;
   wherein the management service and the investor form a member owned entity to fund the convenience; and
   wherein the member owned entity acquires a lease in the convenience.

55. The method of paragraph 54, wherein the owner bears no up-front costs.

56. The method of any of paragraphs 54-55, wherein users use the convenience and a fee for use is paid to the entity.

57. The method of any of paragraphs 54-56, wherein all fees are paid to the entity.

58. The method of any of paragraphs 54-57, wherein the entity is an LLC or an LTD.

59. The method of any of paragraphs 54-58, wherein the customer provides an annual use agreement to the entity.

60. The method of any of paragraphs 54-59, wherein the use agreement is for 10 years.

61. The method of any of paragraphs 54-60, wherein the customer remits all payments to the entity.

62. The method of any of paragraphs 54-61, wherein the company identifies the infrastructure needed and provides infrastructure development.

63. The method of any of paragraphs 54-62, wherein, upon completion of the infrastructure development, the customer provides use of the infrastructure to users.

64. The method of any of paragraphs 64-63, wherein the infrastructure users pay a use fee directly to the entity.

65. The method of any of paragraphs 54-64, wherein the entity engages an accounting firm to collect, disburse and account all funds to all parties.

66. The method of any of paragraphs 54-65, wherein all fees remitted to the entity are maintained by the accounting firm.

67. The method of any of paragraphs 54-66, wherein the accounting firm pays the investor out of use fees on principal and investment.

68. The method of any of paragraphs 54-67, wherein the accounting firm pays the company for repairs to the infrastructure.

69. The method of any of paragraphs 54-68, wherein the accounting firm pays the company a revenue share.

70. The method of any of paragraphs 54-69, wherein the accounting firm pays the customer a revenue share.

71. The method of any of paragraphs 54-70, wherein the accounting firm pays the investor a premium.

72. The method of any of paragraphs 54-71, wherein the accounting firm prepares a monthly/quarterly and year end statements for the entity.

73. The method of any of paragraphs 54-72, wherein all financial data is available to the entity via the computer database.

74. The method of any of paragraphs 54-73, wherein the convenience is coastal.

75. The method of any of paragraphs 54-74, wherein the customer owns water rights or mooring rights in a suitable marina location.

76. The method of any of paragraphs 54-75 wherein coastal includes a fresh water coast or a salt water coast including, rivers, lakes, oceans, seas or other coastal property capable of supporting a marina.

While this invention has been described in conjunction with the various exemplary embodiments outlined above, various alternatives, modifications, variations, improvements and/or substantial equivalents, whether known or that are or may be presently unforeseen, may become apparent to those having at least ordinary skill in the art. Accordingly, the exemplary embodiments according to this invention, as set forth above, are intended to be illustrative not limiting. Various changes may be made without departing from the spirit and scope of the invention. Therefore, the invention is intended to embrace all known or later-developed alternatives, modifications, variations, improvements and/or substantial equivalents of these exemplary embodiments.

What is claimed is:

1. A computerized method for improving the infrastructure of real property comprising:
i. providing a management service including a computerized database comprising:
a) desired property development/improvements and returns/risks associated with the property development/improvement;
b) potential investors interested in investing in property development/improvements;
ii. providing a database on a computer network, the database identifying:
a) the geographical location of suitable property locations;
b) the potential traffic of improved property users;
c) availability of use rights for property owner customer;
d) the potential for return on investment of property infrastructure/improvement; and
iii. identifying a potential property owner customer;
iv. providing a company to perform infrastructure improvements;
v. performing infrastructure improvements in return for lease agreement with no up-front costs to property owner customer.

2. The method of claim 1, further comprising providing an investor, the investor providing a source of investment capital.

3. The method of claim 2, wherein the investor is provided access to the network identifying risks and benefits involved in the investment.

4. The method of claim 1, wherein a company capable of building the infrastructure is identified.

5. The method of claim 4, wherein the investor and the management service form an entity to provide the infrastructure.

6. The method of claim 5, wherein the entity owns the infrastructure.

7. The method of claim 5, wherein the entity is an LLC or an LTD.

8. The method of claim 6, wherein the customer provides an annual use agreement to the entity.

9. The method of claim 7, wherein the use agreement is for 10 years.

10. The method of claim 7, wherein the customer remits all payments to the entity.

11. The method of claim 5, wherein the management service identifies the infrastructure needed and contacts the company to provide infrastructure development.

12. The method of claim 11, wherein, upon completion of the infrastructure development, the customer provides use of the infrastructure to users.

13. The method of claim 12, wherein the infrastructure users pay a use fee directly to the entity.

14. The method of claim 8, wherein the entity engages an accounting firm to collect, disburse and account all funds to all parties.

15. The method of claim 14, wherein all fees remitted to the entity are maintained by the accounting firm.

16. The method of claim 14, wherein the accounting firm pays the investor out of use fees on principal and investment.

17. The method of claim 14, wherein the accounting firm pays the company for repairs to the infrastructure.

18. The method of claim 14, wherein the accounting firm pays the management service a revenue share.

19. The method of claim 14, wherein the accounting firm pays the customer a revenue share.

20. The method of claim 14, wherein the accounting firm pays the investor a premium.

21. The method of claim 14, wherein the accounting firm prepares a monthly/quarterly and year end statements for the entity.

22. The method of claim 25, wherein all financial data is available to the entity via the computer network.

23. The method of claim 1, wherein the property is coastal.

24. The method of claim 1, wherein the customer owns water rights or mooring rights in the suitable marina location.

25. The method of claim 1, wherein the infrastructure improvement is a marina.

26. The method of claim 1, wherein the customer pays no up front costs.

27. The method of claim 1, wherein the customer provides all permits and insurance.

28. The method of claim 1, wherein the investor has access to the network identifying the progress of the infrastructure development and the cost of the development.

29. The method of claim 1, wherein the convenience is a marina.

30. The method of claim 1, wherein the customer pays no up front costs.

31. The method of claim 1, wherein the customer provides all permits and insurance.

32. The method of claim 1, wherein the investor has access to the database network identifying the progress of the infrastructure development and the cost of the development.

33. A method for building a marina comprising:
i. providing a management service to improve or construct a marina;
ii. providing a database on a computer network, the database identifying:
a) the geographical location of suitable marina locations;
b) the potential traffic of marina users;
c) availability of use rights of marina customer;
d) the potential for return on investment of property infrastructure/improvement; and
iii. identifying a potential marina customer;
iv. providing a company to perform infrastructure improvements; and
v. performing infrastructure improvements in return for a moorage agreement with no up-front costs to customer.

34. The method of claim 33 wherein the management service and the investor create an entity.

35. The method of claim 33, wherein the entity takes lien on infrastructure until completion.

36. The method of claim 33, wherein the rights in the infrastructure is a lease on the marina.

37. The method of claim 33, wherein the entity is an LLC or an LTD.

38. The method of claim 33, wherein the company provides liability insurance in the marina.

39. The method of claim 33, wherein the company provides liability indemnification to the entity.

40. The method of claim 33, wherein collecting, accounting and disbursing of moneys is maintained in the computer network.

41. The method of claim 40, wherein the computer network is maintained by an accounting firm.

42. The method of claim 33, wherein the customer provides all permits and insurance.

43. The method of claim 33, wherein the investor funds company for marina and installation costs.

44. The method of claim 43, wherein the company installs a marina.

45. The method of claim 33, wherein the entity engages an accounting firm to collect, disburse and account all funds to all parties.

46. The method of claim 45, wherein all fees remitted to the entity are maintained by the accounting firm.

47. The method of claim 45, wherein the accounting firm pays the investor out of proceeds (10 yr amortized) on principal and interest.

48. The method of claim 45, wherein the accounting firm pays the company for repairs to the marina.

49. The method of claim 45, wherein the accounting firm pays the company a revenue share.

50. The method of claim 45, wherein the accounting firm pays the customer a revenue share.

51. The method of claim 45, wherein the accounting firm pays the investor a premium.

52. The method of claim 45, wherein the accounting firm pays a security company to maintain security at the marina.

53. The method of claim 45, wherein the accounting firm prepares a monthly/quarterly and year end statements for the entity.

54. A method for funding a convenience comprising:
a. providing a computerized database network of customers owning rights in a convenience;
b. providing a computerized database network of potential investors;
c. cross-referencing the database of customers with potential investors to identify investors willing to invest in the convenience;
d. providing a management consultant service controlling a central communications network;
e. providing a member owned entity; and
f. providing a convenience supply company
wherein the management service uses the centra communication network to:
contract with the convenience owner to provide a lease of the convenience;
wherein the management service contracts with a convenience supply company to install the convenience; and
wherein the management service contracts with the investor to fund the convenience;
wherein the management service and the investor form a member owned entity to fund the convenience; and
wherein the member owned entity acquires a lease in the convenience.

55. The method of claim 54, wherein the owner bears no up-front costs.

56. The method of claim 54, wherein users use the convenience and a fee for use is paid to the entity.

57. The method of claim 54, wherein all fees are paid to the entity.

58. The method of claim 54, wherein the entity is an LLC or an LTD.

59. The method of claim 54, wherein the customer provides an annual use agreement to the entity.

60. The method of claim 59, wherein the use agreement is for 10 years.

61. The method of claim 59, wherein the customer remits all payments to the entity.

62. The method of claim 54, wherein the company identifies the infrastructure needed and provides infrastructure development.

63. The method of claim 62, wherein, upon completion of the infrastructure development, the customer provides use of the infrastructure to users.

64. The method of claim 63, wherein the infrastructure users pay a use fee directly to the entity.

65. The method of claim 54, wherein the entity engages an accounting firm to collect, disburse and account all funds to all parties.

66. The method of claim 65, wherein all fees remitted to the entity are maintained by the accounting firm.

67. The method of claim 65, wherein the accounting firm pays the investor out of use fees on principal and investment.

68. The method of claim 65, wherein the accounting firm pays the company for repairs to the infrastructure.

69. The method of claim 65, wherein the accounting firm pays the company a revenue share.

70. The method of claim 65, wherein the accounting firm pays the customer a revenue share.

71. The method of claim 65, wherein the accounting firm pays the investor a premium.

72. The method of claim 65, wherein the accounting firm prepares a monthly/quarterly and year end statements for the entity.

73. The method of claim 54, wherein all financial data is available to the entity via the computer database.

74. The method of claim 54, wherein the convenience is coastal.

75. The method of claim 74, wherein the customer owns water rights or mooring rights in a suitable marina location.

76. The method of claim 74 wherein coastal includes a fresh water coast or a salt water coast including, rivers, lakes, oceans, seas or other coastal property capable of supporting a marina.
